(19) United States
(12) Patent Application Publication
(10) Pub. No.: US 2013/0026954 A1
(43) Pub. Date: Jan. 31, 2013

(54) AUTOMATIC WORK LIGHT ACTIVATION AND DEACTIVATION

(71) Applicant: Bryan D. Sulzer, Dubuque, IA (US)

(72) Inventor: Bryan D. Sulzer, Dubuque, IA (US)

(21) Appl. No.: 13/190,974

(22) Filed: Jul. 26, 2011

(51) Int. Cl. H05B 37/02

(52) U.S. Cl. 315/362

(57) ABSTRACT

An automatic work light control is provided for a work vehicle. The work light may be automatically turned off when a work tool is at or beyond a predetermined height or angle and automatically turned off when the work tool is within the predetermined height or angle.

### FIELD OF THE INVENTION

This disclosure relates to a system and method for automatically activating and de-activating a work light on a vehicle.

### BACKGROUND OF THE INVENTION

Work lights are often used on construction and other work equipment to illuminate a work area as it is being worked by a tool.

### SUMMARY OF THE INVENTION

The invention relates to lighting for a work vehicle. Specifically, illumination may be turned on for at least a portion of a tool and the work area in its vicinity when such illumination is desired and automatically turned off when such illumination is no longer desired. Conditions under which illumination may be desired may include, among other things, a need to observe the work area of the tool when natural or ambient lighting conditions are insufficient for such observations. Conditions under which the illumination may no longer be desired may include a desire to avoid light reflections to a cab of the vehicle when the tool is in a transport position. Such reflections may impair visibility when ambient lighting conditions, for example, nighttime conditions, provide insufficient lighting.

### BRIEF DESCRIPTION OF THE DRAWINGS

FIG. 1 is a side view of an exemplary work vehicle that may utilize the invention;

FIG. 2 shows the vehicle of FIG. 1 with the work tool in a working position;

FIG. 3 shows the vehicle of FIG. 1 with the work tool in a transport position;

FIG. 4 illustrates a block diagram of one embodiment of the invention; and

FIG. 5 illustrates a flow diagram of one embodiment of the invention.

### DESCRIPTION OF THE PREFERRED EMBODIMENT

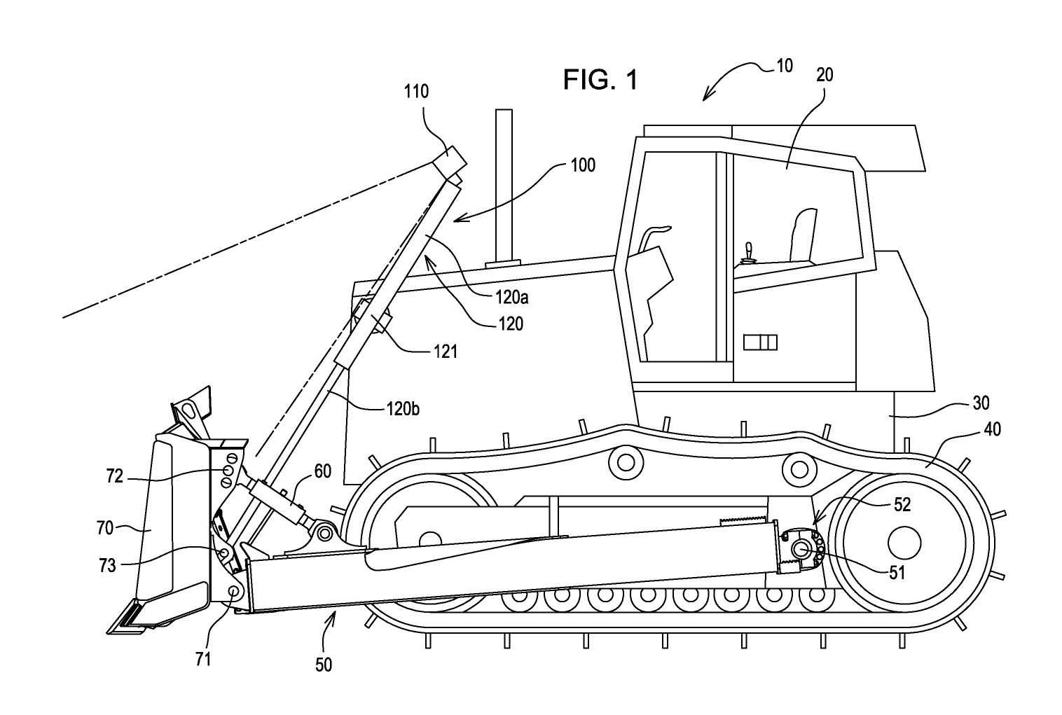

FIG. 1 illustrates an exemplary work vehicle, i.e., a dozer 10, including a cab 20, a frame 30 to which the cab 20 is attached, an undercarriage 40 attached to and supporting the frame 30, a pushbeam 50 pivotally attached to the undercarriage 40 at pushbeam pivot 51, a pitch cylinder 60 pivotally attached to the pushbeam 50 at pitch cylinder pivot 61, a blade 70 pivotally attached to the pushbeam 50 at first blade pivot 71 and the pitch cylinder 60 at second blade pivot 72, and a lift cylinder assembly 100 pivotally attached to the frame 30 at a lift cylinder pivot 121 and the blade 70 at third blade pivot 73.

As illustrated in FIG. 1, the lift cylinder assembly 100 may include: a work light 110; a hydraulic lift cylinder 120 including a hydraulic lift cylinder barrel 120a and a hydraulic lift cylinder rod 120b; and the hydraulic lift cylinder pivot 121 to which the hydraulic lift cylinder barrel 120a may be pivotally attached. The hydraulic lift cylinder 120 may include a commercially available position sensor 120c for sensing a position of the hydraulic lift cylinder 120 and communicating a signal indicative of a length of the hydraulic lift cylinder 120 as it, the hydraulic lift cylinder 120, extends and retracts. The work light 110 may be rigidly attached to the hydraulic lift cylinder barrel 120a.

As indicated earlier, FIG. 1 shows the dozer 10 with the work tool or blade 70 and the work light 110 in a working position. As illustrated, when the blade 70 is in the working position the work light 110 may illuminate a portion of the blade 70 as well as a portion of the material 80 on which the blade 70 works. The material 80 may be earth or any other material the dozer 10 moves such as, for example, rocks, waste, etc.

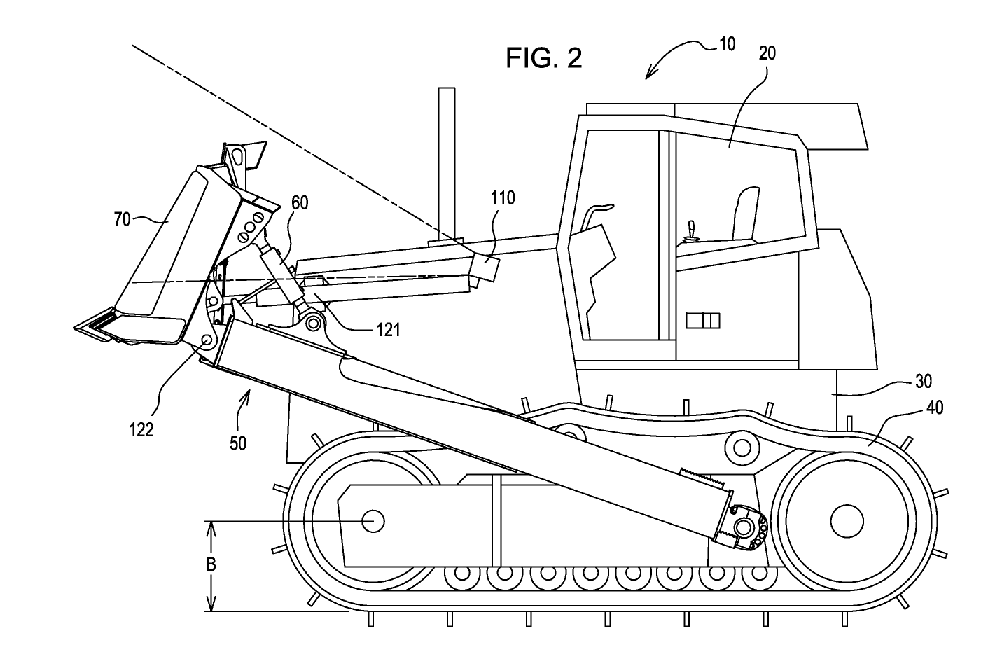

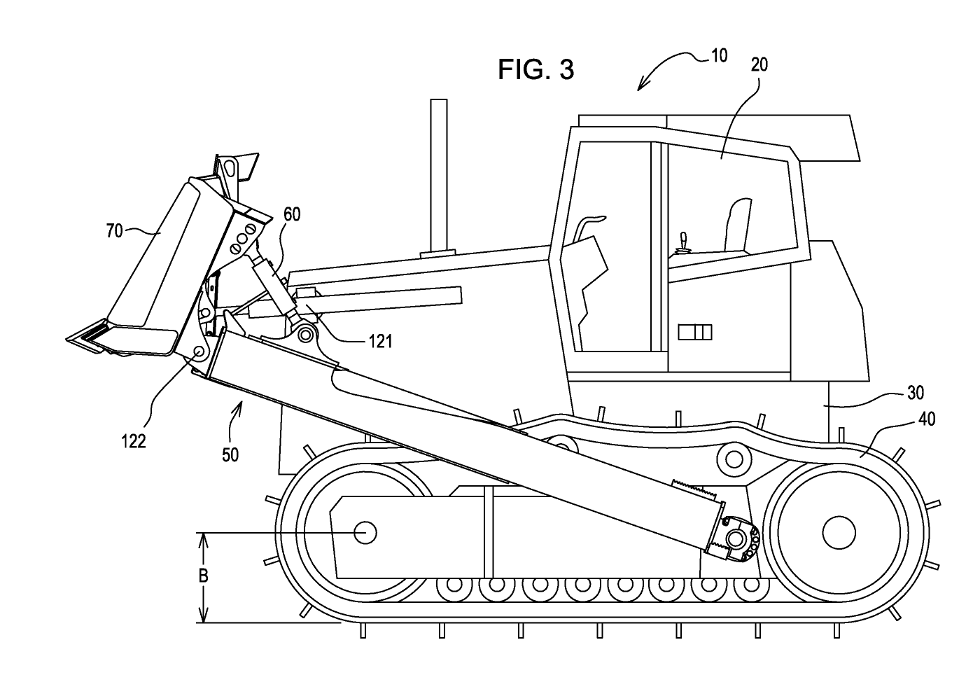

FIG. 2 shows the dozer 10 with the work tool or blade 70 in a transport position and the work light 110 emitting light. The transport position may include any calculated or measured position of the blade 70 that is above a predetermined height, i.e., a height sufficiently above ground level. In this particular embodiment, the predetermined height may be one (1) foot above the bottom of the vehicle B. As illustrated, when the blade 70 is in the transport position, the work light 110 may continue to illuminate a portion of the blade 70 but may not continue to illuminate a relevant portion of the material 80. As illustrated, in this particular scenario, with continued power to the work light 110, the operator is likely to experience undesirable reflections of light from the blade 70 to the cab 20; especially under poor ambient lighting conditions such as, for example, natural lighting conditions during nighttime operations. FIG. 3 illustrates the dozer 10 with the blade 70 in the transport position with the work light 110 turned off.

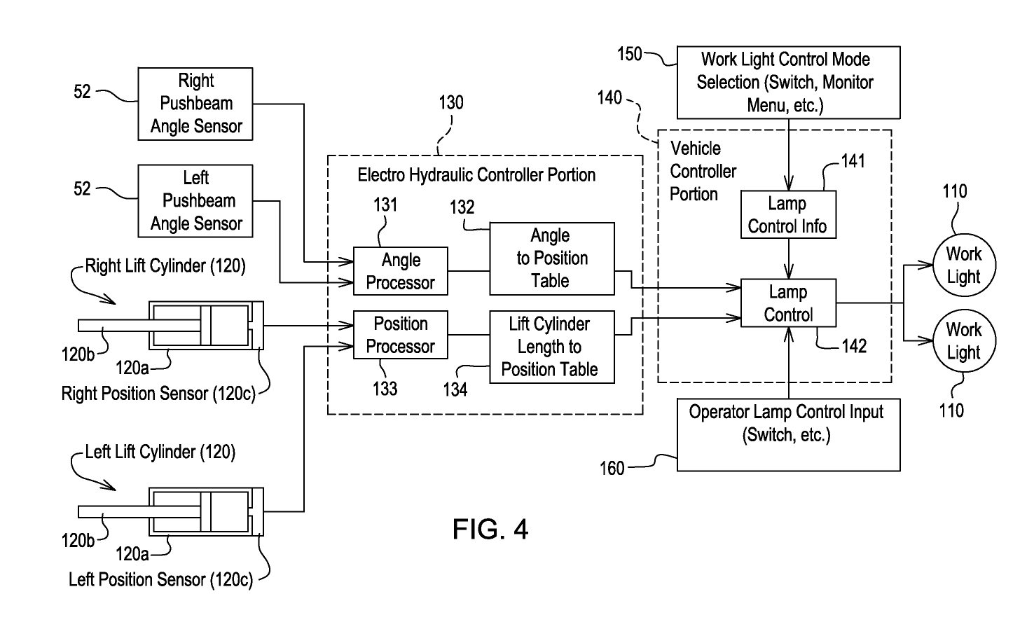

FIG. 4 is an exemplary illustration of a control system 200 for the work light 110 utilizing the invention. As illustrated, the control system 200 may include: pushbeam angle sensors 52; lift position sensors 120c; an electro hydraulic controller portion 130; a vehicle controller portion 140; a work light control mode selector 150 which may have an automatic control mode and a manual control mode; and a conventional operator work light control input device such as, for example, a toggle switch 160 switch the operator may place in an on state or an off state. The electro hydraulic controller portion 130 may include: an angle processor 131; an angle to dozer blade position lookup table 132; a lift cylinder length processor 133; and a lift cylinder length to dozer blade position lookup table 134. The vehicle controller portion 140 may include: a static memory portion 141 containing lamp control information from the work light control mode selector 150; and a lamp controller 142. The angle lookup table 134 may provides some redundancy to the lift cylinder length to dozer blade position lookup table 132 but, when the lift cylinder position sensors 120c are functional, i.e., sending signals, the lamp control 142 may respond to information from the lift cylinder length to position table 132 and not respond to information from the pushbeam angle sensors 52.

The automatic control mode for the exemplary work light control mode selector 150 may provide for automatic work light operation when the work light switch 160 is in an on state. Such an automatic control mode may provide for the work light 110 being automatically turned on when the dozer blade 70 is below a predetermined height or when the dozer blade 70 is at a height equal to or greater than the predetermined height and conventional vehicle headlights (not shown) are turned off. The automatic control mode may provide for the work light 110 to be automatically turned off when the dozer blade 70 is at a height greater than the predetermined blade height and the vehicle headlights (not shown) are turned on. The work light control mode selector 150 provides the control modes described by sending required control information to the vehicle controller portion 140. In this exemplary embodiment, the work light control mode selector 150, which may include predetermined control information for each control mode, sends predetermined work light control information to the static memory portion 141 upon the selection of a control mode via switch, monitor menu plus switch mechanism, touch screen monitor menu or other conventional arrangement. The static memory portion 141 may then provide this information to the lamp controller 142. The lamp controller 142 may then control the work light 110 using the information provided by the static memory portion 141 and the work light switch 160.

The manual control mode for the exemplary work light control mode selector 150 may provide manual control of the work light, i.e., when the work light switch 160 is in an on state, the work light 110 may be on and , when the work light switch is in an off state, the work light may be turned off.

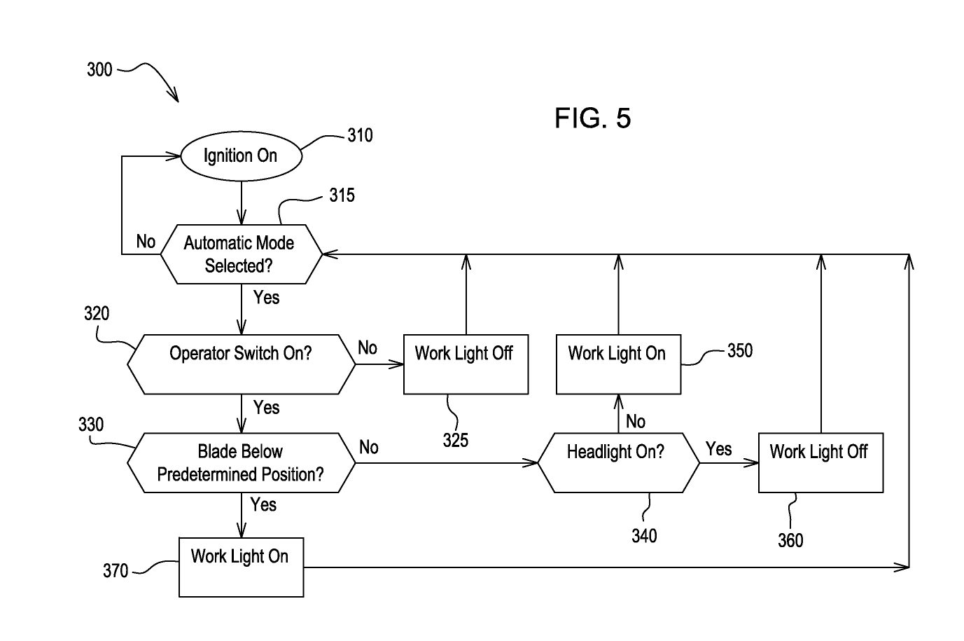

FIG. 5 is an exemplary flow diagram illustrating how the exemplary embodiment of FIG. 4 may work in operation. As illustrated, the process begins once the ignition is turned on at step 310. Once the ignition is on, the vehicle controller 140 may determine whether the automatic mode is selected, i.e., whether the work light mode selector 150 is set for automatic mode at step 315. If the automatic mode is selected, the vehicle controller 140, via the lamp controller 142, determines if the work light switch 160 is in the on state at step 320. If the work light switch 160 is determined to be in the on state at step 320, the height of the blade 70 may be checked at step 330. If the blade 70 is not below a predetermined position at step 330, the headlight of the vehicle 10 may be checked to determine if it, the headlight, is on at step 340. If the headlight is not on at step 340, the work light 110 may remain on at step 350 and the vehicle controller 140 may return to step 320. If the headlight is on at step 340, the work light 110 may be turned off at step 360. If the blade 70 is below the predetermined position at step 330 the work light 110 may be turned on at step 370 regardless of other conditions and the vehicle controller 140 may return to step 320. If the work light switch 160 is determined to be in the off state, the work light 110 is/will be turned off.

Having described the preferred embodiment, it will become apparent that various modifications can be made without departing from the scope of the invention as defined in the accompanying claims.

The invention claimed is:

1. A lighting system for a work vehicle, comprising:
a work tool;
a work light;
a position sensor detecting a position of a working portion of the work vehicle, the working portion operatively connected to the work tool;
a controller having a work light control portion, the work light control portion having a first state and a second state, the position sensor sending position signals to the controller, the controller using the position signals to determine a position of the work tool, the controller placing the work light control portion in the first state when the determined position of the work tool is within a predetermined range of positions.

2. The lighting system of claim 1, wherein the work light controller allows electrical power to flow to the work light when the work light controller is in the first state.

3. The lighting system of claim 1, wherein the work light controller does not allow electrical power to flow to the work light when the work light controller is in the second state.

4. The lighting system of claim 1, wherein the work light controller remains in the first state as long as the determined position of the work tool is within the predetermined range of positions.

5. The lighting system of claim 4, wherein the controller places the work light control in the second state when the determined position of the work tool is not within the predetermined range of positions.

6. The lighting system of claim 4, wherein the controller places the work light control in the second state when the determined position of the work tool is not within the predetermined range of positions.
